(19) United States
(12) Patent Application Publication
(10) Pub. No.: US 2020/0213040 A1
(43) Pub. Date: Jul. 2, 2020

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Liu Liu, Beijing (CN); Huiling Jiang, Beijing (CN); Qin Mu, Beijing (CN); Zhen Liao, Beijing (CN); Yong Li, Beijing (CN); Wenbo Wang, Beijing (CN)

(73) Assignee: NTT DOCOMO, INC., Tokyo (JP)

(21) Appl. No.: 15/751,620

(22) PCT Filed: Aug. 8, 2016
(86) PCT No.: PCT/JP2016/073263

§ 371 Date: Feb. 9, 2018

(30) Foreign Application Priority Data
Aug. 13, 2015 (JP) 2015-159986

(51) Int. Cl. H04L 1/18; H04W 74/08; H04L 1/00; H04W 4/70

(52) U.S. Cl. CPC H04L 1/189; H04W 4/70; H04L 1/0003; H04W 74/0833

(57) ABSTRACT

In order that a user can perform a random access procedure suitable for a case where a usage band is limited to a frequency block that is a part of a system band, a user terminal according to one aspect of the present invention is a user terminal with a usage band limited to a frequency block that is a part of a system band, including a transmission section that transmits a random access signal with repetition, a reception section that receives a response signal to the random access signal with repetition, and a control section that detects a repetition number of the response signal, in which the reception section receives information for detection of the repetition number of the response signal and the control section detects the repetition number of the response signal based on a repetition level of the random access signal and the information for detection.

### TECHNICAL FIELD

The present invention relates to a user terminal, a radio base station, and a radio communication method in the next-generation mobile communication system.

### BACKGROUND ART

In UMTS (Universal Mobile Telecommunications System) networks, for the purpose of higher data rates, low delay and the like, Long Term Evolution (LTE) has been specified (Non-Patent Literature 1). Further, for the purpose of wider bands and higher speed than LTE, a successor system (for example, also referred to as LTE-A (LTE-Advanced), FRA (Future Radio Access), 4G, 5G and the like) to LTE has been studied.

In addition, in recent years, accompanying a reduction in cost of communication apparatuses, the technique of M2M (Machine-to-Machine) communication in which apparatuses connected to a network automatically perform control by communicating with one another without intervention of a person has been developed positively. In particular, 3GPP (Third Generation Partnership Project) is making progress in standardization concerning optimization of MTC (Machine Type Communication) as a cellular system for M2M communication among M2M (Non-Patent Literature 2). It is considered to use an MTC user terminal (MTC UE (User Equipment)) in a wide field of, for example, an electric meter, gas meter, vending machine, vehicle, industrial equipment and the like.

### CITATION LIST

### Non-Patent Literature

[Non-Patent Literature 1] 3GPP TS 36.300 “Evolved Universal Terrestrial Radio Access (E-UTRA) and Evolved Universal Terrestrial Radio Access Network (E-UTRAN); Overall description; Stage 2”
[Non-Patent Literature 2] 3GPP TS 36.888 “Study on provision of low-cost Machine-Type Communications (MTC) User Equipments (UEs) based on LTE (Release 12)”

### SUMMARY OF INVENTION

### Technical Problem

In MTC, from the viewpoint of a reduction in cost and improvement of the coverage area in a cellular system, increasing are demands for the MTC user terminal (LC (Low-Cost)-MTC UE, hereinafter, simply referred to as MTC terminal) that can be actualized by a simple hardware configuration. The MTC terminal is actualized by limiting the usage band of uplink (UL) and downlink (DL) to a frequency block that is a part of the system band. The frequency block is configured by, for example, 1.4 MHz and also called a narrow band (NB).

However, in the case of applying a communication scheme between an existing user terminal (for example, LTE terminal) and a radio base station as it is to the MTC terminal with a usage band limited to a frequency block that is a part of a system band, there is a risk that the MTC terminal cannot properly communicate with the radio base station. For example, it is presumed that a random access procedure between an existing user terminal and a radio base station cannot be applied as it is to the MTC terminal whose usage band is limited to a frequency block that is part of the system band.

The present invention was made in view of such a respect, and it is an object of the invention to provide a user terminal, a radio base station, and a radio communication method capable of performing a random access procedure suitable for a case where a usage band is limited to a frequency block that is a part of a system band.

### Solution to Problem

A user terminal according to one aspect of the present invention is a user terminal with a usage band limited to a frequency block that is a part of a system band, and is characterized by having: a transmission section that transmits a random access signal with repetition; a reception section that receives a response signal to the random access signal with repetition; and a control section that detects a repetition number of the response signal, wherein the reception section receives information for detection of the repetition number of the response signal, and the control section detects the repetition number of the response signal based on a repetition level of the random access signal and the information for detection.

### Advantageous Effects of Invention

According to the present invention, it is possible to perform a random access procedure suitable for a case where a usage band is limited to a frequency block that is a part of a system band.

### BRIEF DESCRIPTION OF DRAWINGS

FIG. 1 is an explanatory diagram of usage bands for an LTE terminal and an MTC terminal;

FIGS. 2A and 2B are explanatory diagrams each showing allocation of a narrow band that is a usage band of the MTC terminal;

FIG. 3 is a diagram showing one example of a random access procedure;

FIGS. 4A, 4B, and 4C are diagrams each showing a control example of an RAR repetition number;

FIG. 5 is a diagram showing one example of RAR repetition numbers according to Aspect 1;

FIG. 6 is a diagram showing one example of a random access procedure according to the Aspect 1;

FIGS. 7A, 7B, and 7C are diagrams each showing one example of offsets of RAR repetition numbers according to Aspect 2;

FIG. 8 is a diagram showing one example of offsets of RAR repetition numbers according to Aspect 3;

FIG. 9 is a diagram showing one example of RAR repetition numbers according to Aspect 4;

FIGS. 10A and 10B are diagrams each showing one example of a TBS table according to the Aspect 4;

FIGS. 11A and 11B are diagrams each showing one example of RAR repetition numbers according to Aspect 5;

FIG. 12 is a schematic configuration diagram of a radio communication system according to an embodiment of the present invention;

FIG. 13 is a diagram showing one example of an entire configuration of a radio base station according to an embodiment of the present invention;

FIG. 14 is a diagram showing one example of a function configuration of a radio base station according to an embodiment of the present invention;

FIG. 15 is a diagram showing one example of an entire configuration of a user terminal according to an embodiment of the present invention; and

FIG. 16 is a diagram showing one example of a function configuration of a user terminal according to an embodiment of the present invention.

### DESCRIPTION OF EMBODIMENTS

For a low-cost MTC user terminal, it has been studied to simplify a hardware configuration by allowing a reduction in processing performance. For example, for a low-cost MTC user terminal, it has been studied to apply a reduction in peak rates, limitation to a Transport Block Size (TBS), limitation to a Resource Block (RB, also called Physical Resource Block (PRB) and the like, hereinafter, referred to as PRB), limitation to a reception Radio Frequency (RF) and the like, as compared with the existing user terminal.

Herein, the existing user terminal is called an LTE terminal, an LTE-A terminal, an LTE UE (User Equipment), a normal UE, a non-MTC terminal, simply a user terminal, a UE and the like. Further, the MTC terminal is also called simply a user terminal, UE and the like. In the following, for convenience of description, the existing user terminal is called an LTE terminal and the MTC (a low-cost MTC) user terminal is called an MTC terminal.

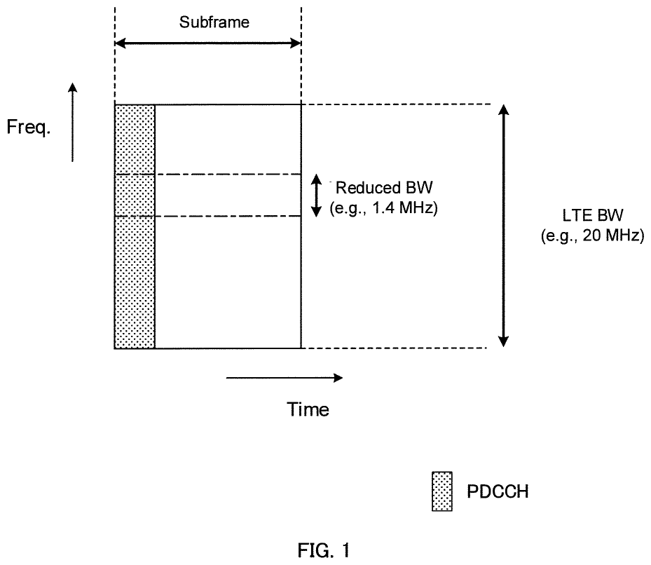

FIG. 1 is an explanatory diagram of usage bands of an LTE terminal and an MTC terminal. As shown in FIG. 1, the upper limit of the usage band of the LTE terminal is set to the system band (for example, 20 MHz (=100 PRBs), 1 component carrier and the like). On the other hand, the upper limit of the usage band of the MTC terminal is limited to a frequency block (for example, 1.4 MHz (=6 PRBs)) that is a part of the system band. Hereinafter, the frequency block is also called a “narrow band (NB)”.

Further, it is studied that the MTC terminal operates within the system band of LTE/LTE-A. In this case, it is possible to support frequency division multiplexing of the MTC terminal and the LTE terminal. Thus, the MTC terminal is also said to be a user terminal whose supporting maximum band is a frequency block (narrow band) that is a part of the system band, and is also said to be a user terminal having transmission/reception performance of a band narrower than the system band of LTE/LTE-A.

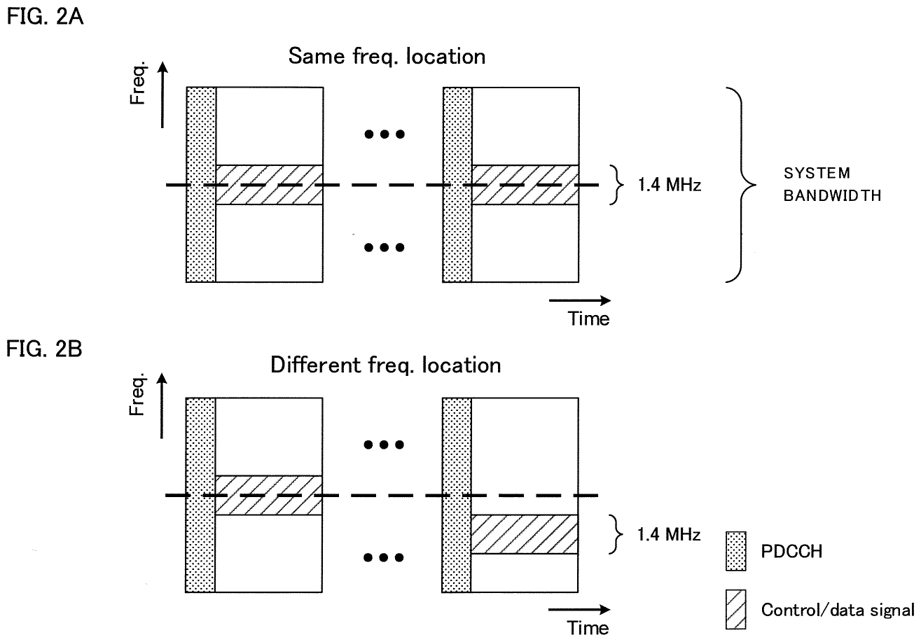

FIGS. 2A and 2B are explanatory diagrams each showing allocation of a narrow band that is the usage band of the MTC terminal. As shown in FIG. 2A, it is conceived to fix the narrow band (for example, 1.4 MHz) to a particular frequency position within the system band (for example, 20 MHz). In this case, there is a risk that traffic concentrates on the particular frequency (for example, center frequency). Further, the frequency diversity effect is not obtained, and therefore, there is a risk that frequency utilization efficiency is reduced.

Therefore, it is conceived to change the narrow band (for example, 1.4 MHz) to a different frequency position (frequency resource) within the system band (for example, 20 MHz) during a predetermined period of time (for example, subframe) as shown in FIG. 2B. In this case, it is possible to disperse the traffic of the MTC terminal. Further, the frequency diversity effect is obtained, and therefore, it is possible to suppress a reduction in frequency utilization efficiency.

As shown in FIG. 2B, in the case where the frequency position of the narrow band that is the usage band of the MTC terminal is variable, it is preferable for the MTC terminal to have a retuning function of RF in view of application of frequency hopping or frequency scheduling for the narrow band.

In addition, the MTC terminal supports only the narrow band (for example, 1.4 MHz) that is a part of the system band, and therefore, it is not possible to detect a downlink control channel (PDCCH: Physical Downlink Control Channel) allocated across the entire system band. Therefore, it is studied to assign resources of a downlink shared channel (PDSCH) and uplink shared channel (PUSCH: Physical Uplink Shared Channel) using an MTC downlink control channel (MPDCCH: Machine type communication PDCCH) allocated in the narrow band.

Herein, the MTC downlink control channel (MPDCCH) is a downlink control channel (downlink control signal) transmitted with the narrow band that is a part of the system band, and may be frequency division multiplexed with the LTE or MTC downlink shared channel (PDSCH: Physical Downlink Shared Channel). MPDCCH may be called M-PDCCH (Machine type communication-PDCCH), enhanced downlink control channel (EPDCCH: Enhanced Physical Downlink Control Channel) and the like. Downlink Control Information (DCI: Downlink Control Channel) including information on assignment of the PDSCH (for example, DL (Downlink) grant), information on assignment of the PUSCH (for example, UL (Uplink) grant) and the like is transmitted on the MPDCCH.

Note that it may also be possible to represent a channel that is used by the MTC terminal by attaching “M” indicating MTC to the existing channel used for the same purpose, in addition to the MPDCCH. For example, the PDSCH assigned on the MPDCCH may also be called MPDSCH (Machine type communication PDSCH), M-PDSCH (Machine type communication-PDSCH) and the like. Similarly, the PUSCH assigned on the MPDCCH may also be called MPUSCH (Machine type communication PUSCH), M-PUSCH (Machine type communication-PUSCH) and the like.

In addition, in MTC, it is also studied to perform repetitive transmission/reception to transmit/receive with repetition the same downlink signal and/or uplink signal across a plurality of subframes to enhance coverage. Note that the number of a plurality of subframes in which the same downlink signal and/or uplink signal is transmitted/received is also called repetition number. The repetition number may be indicated by a repetition level. Further, the repetition level is also called Coverage Enhancement (CE) level.

In the repetitive transmission/reception, the downlink signals and/or uplink signals received across a plurality of subframes are combined, and therefore, even in the case where a narrow band is used, it is possible to satisfy a desired Signal-to-Interface plus Noise Ratio (SINR). As a result, it is possible to enhance the coverage of MTC.

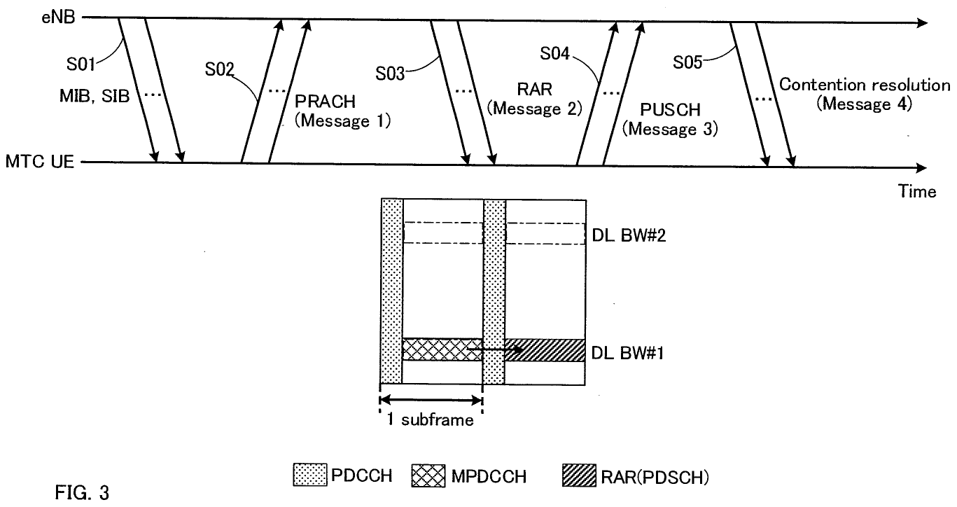

Further, in order for an MTC terminal to establish uplink synchronization, it is necessary to perform a random access procedure between the MTC terminal and a radio base station. FIG. 3 is a diagram showing one example of a random access procedure. Note that FIG. 3 shows a contention-based random access procedure, but not only this but also a contention-free random access procedure may be used. Note that, in FIG. 3, the case is assumed where repetitive transmission/reception is performed as one example.

As shown in FIG. 3, an MTC terminal (MTC UE) receives system information (for example, MIB: Mater Information Block, SIB: System Information Block) from a radio base station (eNB) (step S01). For example, the MTC terminal sets an uplink narrow band and a downlink narrow band based on MTC SIB. Note that a plurality of uplink narrow bands may also be set. Similarly, a plurality of downlink narrow bands (for example, in FIG. 3, DL BW#1 and BW#2) may also be set.

The MTC terminal transmits a random access preamble via a random access channel (PRACH: Physical Random Access Channel) using the PRACH resource notified with SIB (step S02). It is possible to determine a PRACH CE level based on received power (for example, RSRP (Reference Signal Received Power)) measured by UE, received quality (for example, RSRQ (Reference Signal Received Quality)), channel state and the like. Then, the UE transmits the PRACH with repetition using the determined CE level. The random access preamble is used for estimation of a delay between the MTC terminal and the radio base station and also called Message 1, PRACH. In the following, it is assumed that the random access preamble is called PRACH.

The radio base station transmits a Random Access Response (RAR) via PDSCH in response to reception of PRACH (step S03). For example, the radio base station determines the repetition number based on the PRACH repetition level (CE level) to transmit RAR with repetition. RAR is also called Message 2 and includes, for example, uplink synchronization delay information (UL delay) and the like. Further, the radio base station transmits DCI including RAR resource assignment information on the MPDCCH using RA-RNTI (Random Access-Radio Network Temporary Identifier).

Note that, in FIG. 3, MPDCCH that transmits the above-mentioned DCI and PDSCH that transmits RAR are assigned to downlink narrow band #1 (DL BW#1) as one example, but assignment is not limited thereto. It is also possible to dynamically assign the PDSCH on the MPDCCH even if the downlink narrow band is not set with SIB.

The MTC terminal blind-decodes MPDCCH (for example, Common Search Space (CSS)) to detect RA-RNTI. The MTC terminal specifies an assignment resource of RAR on PDSCH based on the detected RA-RNTI to receive RAR. Note that, in the case where it is not possible to receive RAR from the transmission of PRACH within a predetermined period of time, the MTC terminal increases the transmission power of the PRACH to retransmit the PRACH.

Upon receipt of RAR, the MTC terminal transmits Layer 2/Layer 3 (L2/L3) Message such as an RRC (Radio Resource Control) connection request to the radio base station via PUSCH (step S04). The L2/L3 Message is also called Message 3 and includes a mobile terminal identifier. Note that the L2/L3 Message may be transmitted with the narrow band with which PRACH is received by the radio base station. This can improve reception accuracy of the L2/L3 Message.

The radio base station transmits a contention resolution message to the MTC terminal via PDSCH in response to the L2/L3 Message from the MTC terminal (step S05). The MTC terminal determines whether or not the random access procedure has succeeded based on the mobile terminal identifier included in the contention resolution message.

However, with the above-mentioned random access procedure (for example, FIG. 3), as a result that it is not possible for the MTC terminal to detect the RAR repetition number from the radio base station, there is a risk that RAR cannot be received properly.

Specifically, the radio base station, when simultaneously detecting PRACHs from a plurality of MTC terminals, can transmit response messages to the respective MTC terminals by including them in the single RAR. In this case, it is conceived that the radio base station multiplexes a plurality of MTC terminals whose PRACH repetition levels are the same within the single RAR.

However, even though the PRACH repetition levels are the same, it is presumed that the RAR repetition numbers to satisfy the desired SINR are different depending on the number of MTC terminals multiplexed within the RAR. Therefore, it is desirable to control the RAR repetition number based on not only the PRACH repetition level but also the number of MTC terminals multiplexed within the single RAR.

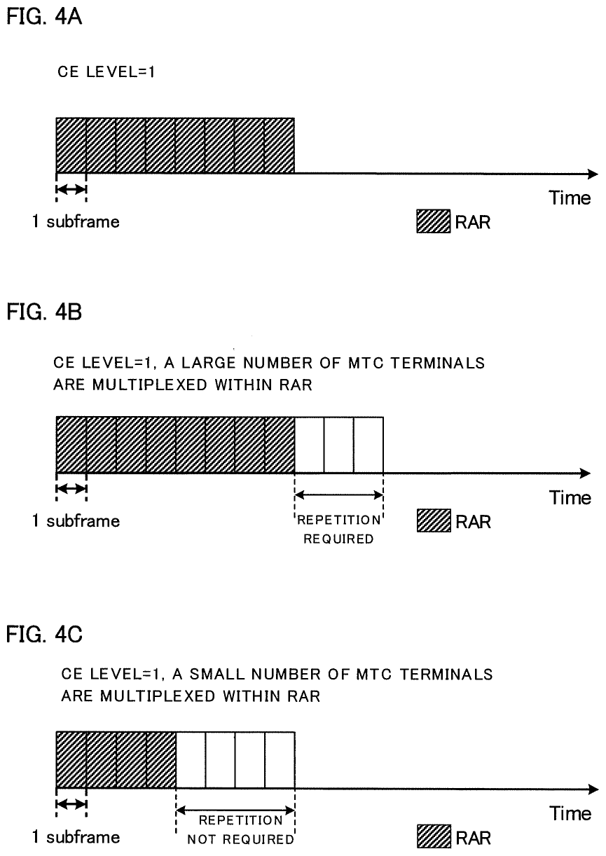

FIGS. 4A, 4B, and 4C are diagrams each showing a control example of the RAR repetition number. Herein, as shown in FIG. 4A, the case is assumed where the RAR repetition number corresponding to the PRACH repetition level (CE level) 1 is 8. In the case where a large number of MTC terminals (for example, 3 MTC terminals) are multiplexed within RAR, the amount of RAR information increases. Therefore, it is necessary to increase the RAR repetition number to satisfy the desired SINR larger than 8 corresponding to the PRACH repetition level 1 as shown in FIG. 4B.

On the other hand, in the case where a small number of MTC terminals (for example, only 1 MTC terminal) are multiplexed within RAR, the amount of RAR information decreases. Therefore, the RAR repetition number to satisfy the desired SINR may be smaller than 8 corresponding to the PRACH repetition level 1 as shown in FIG. 4C.

Thus, even when the PRACH repetition numbers are the same, the RAR repetition numbers to satisfy the desired SINR are different depending on the number of MTC terminals multiplexed within RAR, and therefore, it is conceived that the radio base station controls the RAR repetition number based on the number of MTC terminals multiplexed within RAR. In this case, as a result that it is not possible for the MTC terminal to detect the RAR repetition number controlled by the radio base station, there is a risk that RAR cannot be received properly.

Therefore, the inventors of the present invention conceived to make it possible to properly notify the MTC terminal of the RAR repetition number controlled by the radio base station in the case where repetitive transmission is used in the random access procedure between the MTC terminal and the radio base station, and arrived at the present invention.

In one aspect of the present invention, an MTC terminal (user terminal) with a usage band limited to a narrow band (frequency block) that is a part of a system band transmits PRACH (random access signal) with repetition to receive RAR (response signal) to PRACH with repetition. The MTC terminal receives information for detection of an RAR repetition number. The MTC terminal detects the RAR repetition number based on a PRACH repetition level and the information for detection.

Herein, the information for detection of the RAR repetition number may be information indicating the number of user terminals multiplexed within RAR (Aspect 1), may be information indicating an offset to the PRACH repetition number (Aspect 2, Aspect 3), may be information indicating a Transport Block Size (TBS) of RAR (Aspect 4), or may be information indicating a plurality of narrow bands that is candidates of usage bands (Aspect 5).

A radio communication method according to an embodiment of the present invention will be described below in detail. Note that, in the following, it is assumed that the narrow band (frequency block) that is a part of the system band is 1.4 MHz and consists of six resource blocks (PRB), but the configuration is not limited thereto. Further, in the following, it is assumed that the PRACH repetition level has three levels, but the number of levels is not limited to three. Furthermore, the RAR repetition numbers shown below are merely examples and are not limited to the examples.

### Aspect 1

In Aspect 1, an MTC terminal receives information indicating the number of MTC terminals (user terminals) multiplexed within RAR (response signal) as the above-mentioned information for detection. The MTC terminal detects an RAR repetition number based on a PRACH repetition level and the number of MTC terminals.

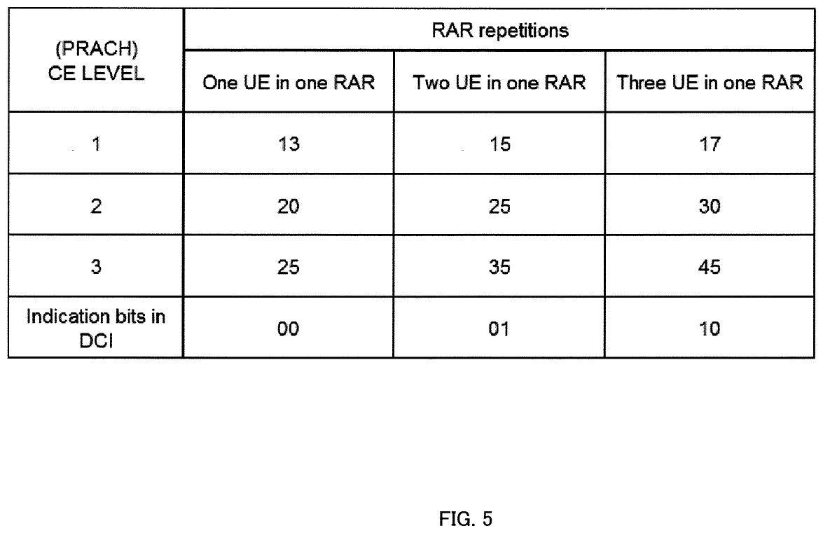

FIG. 5 is a diagram showing one example of associating the PRACH repetition level (CE level) with the RAR repetition number. As shown in FIG. 5, the PRACH repetition level and the RAR repetition number are associated with each other for each number of MTC terminals multiplexed within RAR. The RAR repetition number for each repetition level and for each number of MTC terminals in FIG. 5 may be determined (stored) in advance in the MTC terminal, or may be notified to the MTC terminal by higher layer signaling (for example, RRC signaling). Note that the repetition numbers shown in FIG. 5 are merely examples and not limited thereto.

Further, as shown in FIG. 5, the number of MTC terminals multiplexed within RAR is associated with a bit value within DCI transmitted on MPDCCH. For example, in FIG. 5, the above-mentioned numbers of MTC terminals “1”, “2”, and “3” are associated with the bit values “00”, “01”, and “10”, respectively. Note that, in FIG. 5, the maximum multiplexing number within RAR is 3, but is not limited to 3. When the maximum multiplexing number is 5 or more, it is sufficient to set the number of bits of DCI to 3 or more, and when it is 2 or less, it is sufficient to set it to 1.

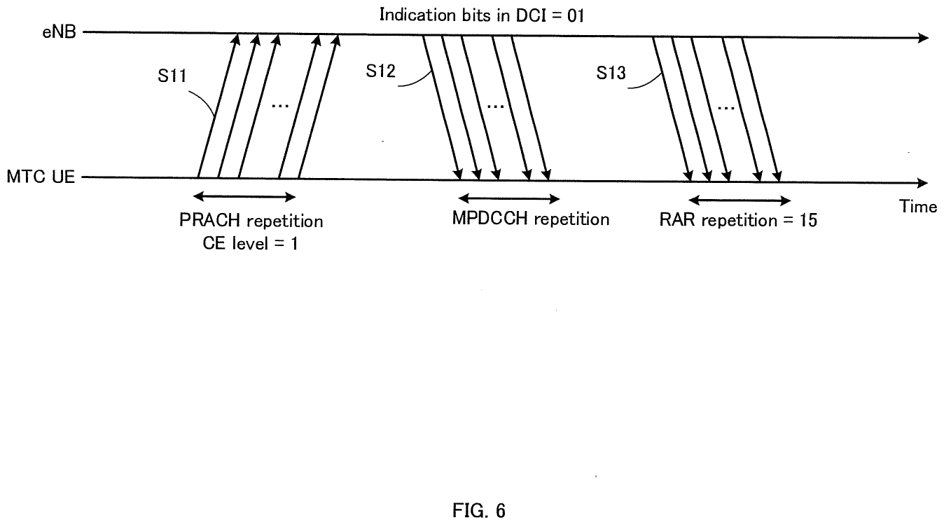

One example of a random access procedure using information indicating the number of MTC terminals as above will be described. FIG. 6 is a diagram showing one example of a random access procedure according to Aspect 1. Note that, in FIG. 6, operations concerning steps S01, S04, and S05 in FIG. 3 are not shown, but it is possible to apply the operations as appropriate. Further, in FIG. 6, it is assumed that the RAR repetition number shown in FIG. 5 is set in advance, or set by higher layer signaling to the radio base station and the MTC terminal.

As shown in FIG. 6, in the case of applying repetitive transmission/reception to the above-mentioned random access procedure, the MTC terminal determines the PRACH repetition level (CE level) based on the result of measurement (for example, received signal intensity (RSRP: Reference Signal Received Power) and received signal quality (RSRQ: Reference Signal Received Quality)) to perform repetitive transmission of PRACH based on the repetition level (step S11). For example, in FIG. 6, the MTC terminal determines the repetition level 1.

Note that, in the case where different PRACH resources are assigned for each different repetition level, the radio base station can know the PRACH repetition level. The PRACH repetition level may be notified to the radio base station from the MTC terminal or may be estimated by the radio base station based on the result of measurement in the MTC terminal.

The radio base station determines the RAR repetition number based on the PRACH repetition level and the number of MTC terminals multiplexed within RAR. For example, in FIG. 6, the PRACH repetition level is 1 and the number of MTC terminals multiplexed within RAR is 2, and therefore, the radio base station determines the repetition number “15” associated with the repetition level “1” and the number of MTC terminals “2” in FIG. 5

The radio base station transmits DCI including information indicating the number of MTC terminals multiplexed within RAR (herein, the bit value “01” indicating the number of MTC terminals “2”) via MPDCCH (step S12). Herein, the information indicating the number of MTC terminals may be information that uses an existing field (for example, MCS (Modulation and Coding Scheme) field) within DCI, or may be information that uses a new field.

The MTC terminal receives information indicating the number of MTC terminals multiplexed within RAR (herein, the bit value “01” indicating the number of MTC terminals “2”) from the radio base station via MPDCCH. The MTC terminal detects the repetition number “15” associated with the number of MTC terminals “2” and the PRACH repetition level “1” in FIG. 5. The MTC terminal receives RARs across a plurality of subframes based on the detected repetition number to combine the RARs (step S13).

According to Aspect 1, since information indicating the number of MTC terminals multiplexed within RAR is notified from the radio base station, the MTC terminal can detect the RAR repetition number based on the number of MTC terminals and the PRACH repetition level and receive the RAR properly.

### Aspect 2

In Aspect 2, the MTC terminal receives information indicating an offset to the PRACH (random access signal) repetition number as the above-mentioned information for detection. Herein, the offset is defined for each PRACH repetition level. The MTC terminal detects the RAR repetition number based on the repetition number indicated by the PRACH repetition level and the offset.

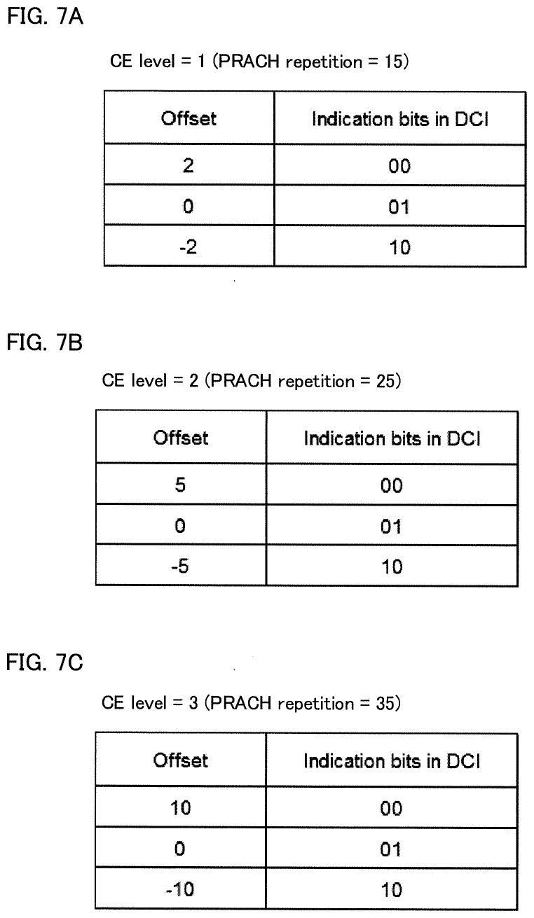

FIGS. 7A, 7B, and 7C are diagrams each showing one example of information indicating an offset to the PRACH repetition number. As shown in FIGS. 7A, 7B, and 7C, the offset may be defined for each PRACH repetition level (CE level). FIGS. 7A, 7B, and 7C show offsets at the PRACH repetition levels 1, 2, and 3, and information indicating the offsets (for example, the bit values in DCI), respectively.

As shown in FIGS. 7A to 7C, the offset at each repetition level is associated with the bit value in DCI transmitted on MPDCCH. For example, in FIG. 7A, the offsets “2”, “0”, and “−2” are associated with the bit values “00”, “01”, and “10”, respectively. This also applies to the repetition levels 2 and 3 shown in FIGS. 7B and 7C. Note that the offset value indicated by each bit value may be stored in advance, or may be set by higher layer signaling.

Further, as shown in FIG. 7A, the range of the offset at the repetition level1 is 2, 0, and −2, as shown in FIG. 7B, the range of the offset at the repetition level 2 is 5, 0, and −5, and as shown in FIG. 7C, the range of the offset at the repetition level 3 is 10, 0, and −10. Thus, the offset range at each repetition level may also be set so as to increase in accordance with the repetition number.

One example of a random access procedure using information indicating the offset for each repetition level as described above will be described. Note that it is possible to apply the sequence described in FIG. 6 to the random access procedure as appropriate.

For example, it is assumed that in the case where the number of MTC terminals multiplexed within RAR at the PRACH repetition level 1 is 3, the radio base station determines the offset “2” shown in FIG. 7A based on the repetition level and the number of MTC terminals. The radio base station transmits DCI including information indicating the offset “2” (herein, the bit value “00”) via MPDCCH. Note that the information indicating the offset may be information that uses an existing field (for example, MCS field) within DCI, or may be information that uses a new field.

The MTC terminal receives information indicating an offset (herein, the bit value “00” indicating the offset “2”) from the radio base station via MPDCCH. The MTC terminal detects the RAR repetition number “17 (=15+2)” based on the offset “2” associated with the bit value “00” in FIG. 7A and the repetition number “15” indicated by the PRACH repetition level 1.

According to Aspect 2, since information indicating the offset to the PRACH repetition number is notified from the radio base station, the MTC terminal can detect the RAR repetition number based on the offset and the repetition number indicated by the PRACH repetition level and receive RAR properly. Further, as shown in FIGS. 7A to 7C, by associating an offset with information indicating the offset (bit value in DCI) for each repetition level, it is possible to prevent an increase in the amount of information indicating the offset (number of bits in DCI).

### Aspect 3

In Aspect 3, as in Aspect 2, the MTC terminal receives information indicating an offset to the PRACH (random access signal) repetition number as the information for detection. On the other hand, Aspect 3 differs from Aspect 2 in that the offset is defined in common to all the PRACH repetition levels. In the following, a point different from Aspect 2 will be described mainly.

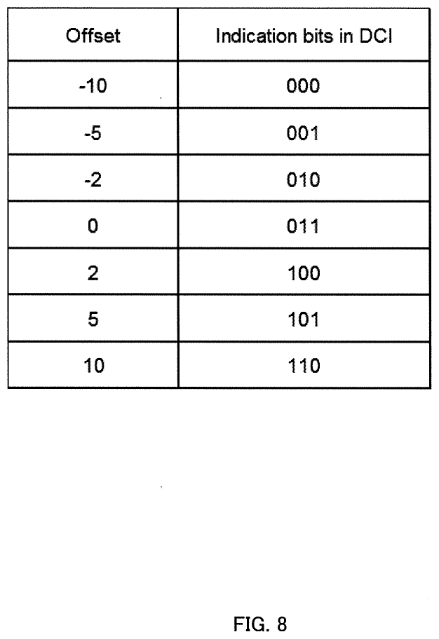

FIG. 8 is a diagram showing another example of information indicating an offset to the PRACH repetition number. As shown in FIG. 8, the offset may be defined in common to all the PRACH repetition levels (CE levels).

As shown in FIG. 8, the offset common to the repetition levels 1 to 3 is associated with the bit value in DCI transmitted on MPDCCH. Note that the offset value indicated by each bit value may be stored in advance, or may be set by higher layer signaling.

One example of a random access procedure using information indicating the offset common to the repetition levels as above will be described below. Note that it is possible to apply the sequence described in FIG. 6 to the random access procedure as appropriate.

For example, it is assumed that when the number of MTC terminals multiplexed within RAR at the PRACH repetition level 3 is 1, the radio base station determines the offset “−10” shown in FIG. 8 based on the repetition level and the number of MTC terminals. The radio base station transmits DCI including information indicating the offset “−10” (herein, the bit value “000”) via MPDCCH. Note that the information indicating the offset may be information that uses an existing field (for example, MCS field) in DCI, or information that uses a new field.

The MTC terminal receives information indicating an offset (here, the bit value “000” indicating the offset “−10”) from the radio base station via MPDCCH. The MTC terminal detects the RAR repetition number “25 (=35−10)” based on the offset “−10” associated with the bit value “000” in FIG. 8 and the repetition number “35” indicated by the PRACH repetition level 3.

According to Aspect 3, since information indicating the offset to the PRACH repetition number is notified from the radio base station, the MTC terminal can detect the RAR repetition number based on the offset and the repetition number indicated by the PRACH repetition level and receive RAR properly.

### Aspect 4

In Aspect 4, the MTC terminal receives information indicating Transport Block Size (TBS) of RAR (response signal) as the above-mentioned information for detection. Herein, the TBS is associated with the number of MTC terminals (number of user terminals) multiplexed within RAR. The MTC terminal detects the RAR repetition number based on the PRACH repetition level and the TBS. Note that, in the following, a point different from Aspect 1 will be described mainly.

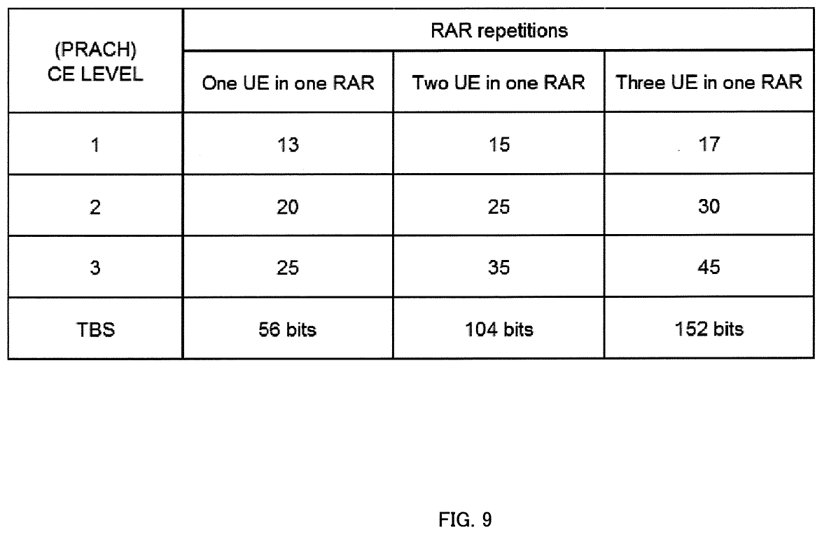

FIG. 9 is a diagram showing another example of associating the PRACH repetition level (CE level) with the RAR repetition number. As shown in FIG. 9, the PRACH repetition level and the RAR repetition number are associated with each other for each number of MTC terminals multiplexed within RAR. The RAR repetition number for each repetition level and for each number of MTC terminals in FIG. 9 may be determined (stored) in advance in the MTC terminal, or may be notified to the MTC terminal by higher layer signaling (for example, RRC signaling). Note that the repetition numbers shown in FIG. 9 are merely examples and not limited thereto.

Further, as shown in FIG. 9, the number of MTC terminals multiplexed within RAR is associated with the Transport Block Size (TBS) used for transmission of RAR. For example, in FIG. 9, the above-mentioned numbers of MTC terminals “1”, “2”, and “3” are associated with the TBSs “56”, “104”, and “152”, respectively. Note that, in FIG. 9, the maximum multiplexing number within RAR is 3, but not limited thereto. Further, the TBSs associated with the numbers of MTC terminals are also not limited to those shown in FIG. 9.

One example of a random access procedure using TBS as above will be described. Note that it is possible to apply the sequence described in FIG. 6 to the random access procedure as appropriate.

The radio base station determines the RAR repetition number based on the PRACH repetition level and the number of MTC terminals multiplexed within RAR. For example, the PRACH repetition level is 1 and the number of MTC terminals multiplexed within RAR is 1, and therefore, the radio base station determines the repetition number “13” associated with the repetition level “1” and the number of MTC terminals “1” in FIG. 9.

The radio base station transmits DCI including information indicating the TBS “56” associated with the number of MTC terminals multiplexed within RAR “1” via MPDCCH. Herein, the information indicating the TBS may be the MCS index associated with the TBS index indicating the TBS. The MCS index is associated with the modulation order and the TBS index in the MCS table (not shown schematically). The above-mentioned TBS may be indicated by the TBS index associated with the MCS index, or may be indicated by the TBS index and the number of PRBs (number of resource blocks) assigned to RAR.

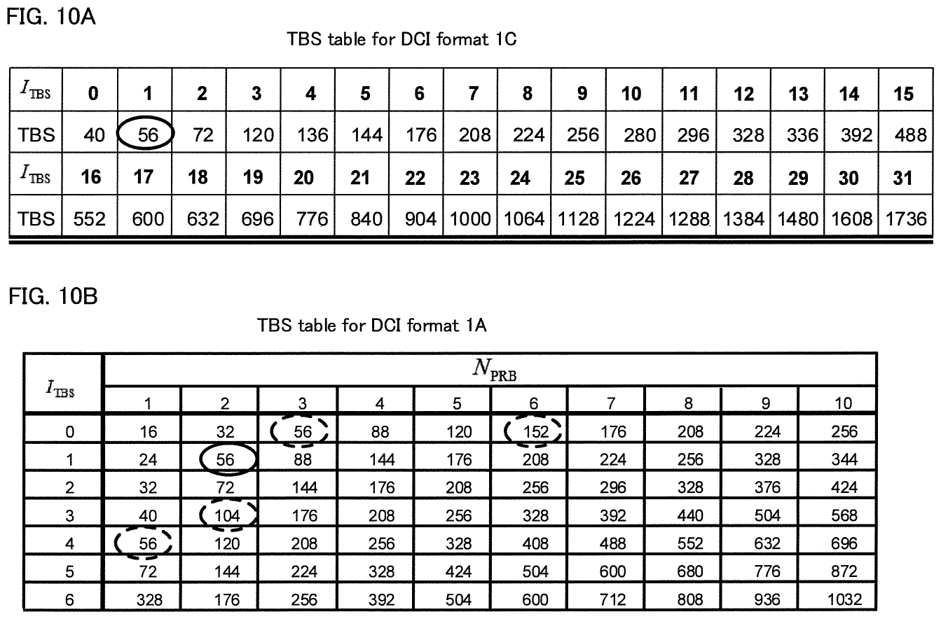

For example, in the case where the above-mentioned MCS index is included in a DCI format 1C, the MTC terminal acquires the TBS index 1 associated with the MCS index in the MCS table (not shown schematically). Further, the MTC terminal acquires the TBS “56” associated with the TBS index 1 in the TBS table shown in FIG. 10A. The MTC terminal detects the RAR repetition number “13” associated with the PRACH repetition level “1” and the above-mentioned TBS “56” in FIG. 9.

Alternatively, in the case where the above-mentioned MCS index is included in a DCI format 1A, the MTC terminal acquires the TBS index 1 associated with the MCS index in the MCS table (not shown schematically). Further, the MTC terminal acquires the TBS “56” associated with the TBS index 1 and the number of PRBs (herein, assumed to be “2”) assigned to RAR in the TBS table shown in FIG. 10B. The MTC terminal detects the RAR repetition number “13” associated with the PRACH repetition level “1” and the above-mentioned TBS “56” in FIG. 9.

Note that the TBS tables shown in FIGS. 10A and 10B are merely examples and not limited thereto. For example, in FIG. 10A, the TBS indexes up to 31 are shown, but a TBS index larger than or equal to 32 may be provided. Similarly, in FIG. 10B, the TBS indexes up to 6 are shown, but a TBS index larger than or equal to 6 may be provided. Further, TBSs corresponding to the number of PRBs larger than or equal to 11 may be specified.

According to Aspect 4, since information indicating TBS associated with the number of MTC terminals multiplexed within RAR is notified from the radio base station, the MTC terminal can detect the RAR repetition number based on the TBS and the PRACH repetition level and receive RAR properly. Further, by using the MCS index as information indicating TBS, it is possible to notify the RAR repetition number implicitly without changing the existing DCI format.

### Aspect 5

In Aspect 5, the MTC terminal receives information indicating a plurality of narrow bands (frequency blocks) as the above-mentioned information for detection. Herein, each of the plurality of narrow bands is associated with the number of MTC terminals (number of user terminals) multiplexed within RAR (response signal). The MTC terminal detects the RAR repetition number based on the PRACH repetition level and the narrow band to which RAR is assigned. Note that, in the following, a point different from Aspect 1 will be described mainly.

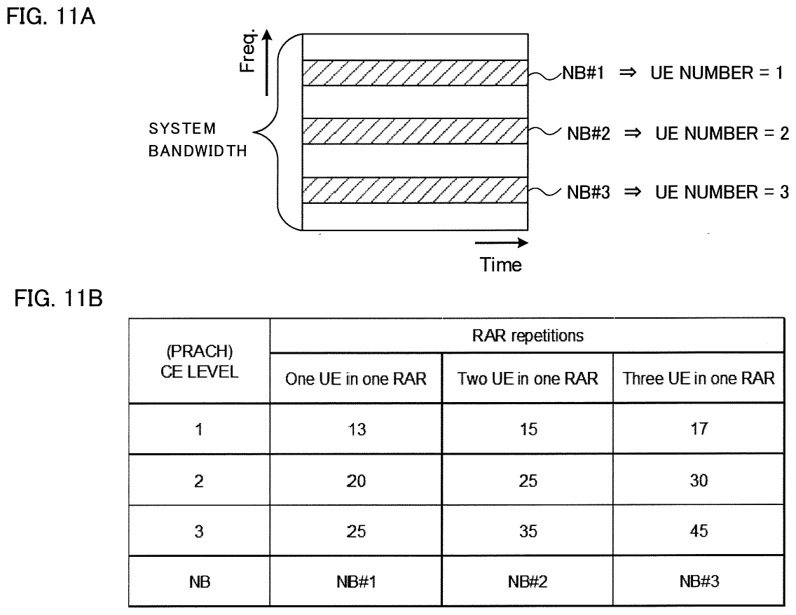

FIGS. 11A and 11B are diagrams each showing one example of associating a plurality of narrow bands with the number of MTC terminals multiplexed within RAR. As shown in FIG. 11A, the case is assumed as one example where a plurality of narrow bands (NBs) #1 to #3 that are candidates of the usage bands of the MTC terminal is set. In FIG. 11B, the narrow bands #1 to #3 are associated with the numbers of MTC terminals multiplexed within RAR “1” to “3”, respectively.

Note that the plurality of narrow bands shown in FIG. 11A may be initially set in advance, or may be set by higher layer signaling (for example, RRC, SIB and the like). Further, the number of MTC terminals associated with each narrow band in FIG. 11B may also be initially set in advance, or may be set by higher layer signaling. Furthermore, the RAR repetition number for each repetition level and for each number of MTC terminals (narrow band) in FIG. 11B may be determined (stored) in advance in the MTC terminal, or may be notified to the MTC terminal by higher layer signaling. Note that the repetition numbers shown in FIG. 11B are merely examples and not limited thereto.

One example of a random access procedure using the narrow bands as above will be described. The radio base station determines the RAR repetition number based on the PRACH repetition level and the number of MTC terminals multiplexed within RAR. For example, the PRACH repetition level is 1 and the number of MTC terminals multiplexed within RAR is 1, and therefore, the radio base station determines the repetition number “13” associated with the repetition level “1” and the number of MTC terminals “1” in FIG. 11B.

The radio base station transmits the RAR using the narrow band #1 associated with the number of MTC terminals multiplexed within RAR “1”. The MTC terminal detects that the RAR is assigned to the narrow band #1 on MPDCCH. The MTC terminal detects the RAR repetition number “13” associated with the PRACH repetition level “1” and the narrow band #1 in FIG. 11B.

According to Aspect 5, since the number of MTC terminals multiplexed within RAR is associated with the narrow band by the radio base station, the MTC terminal can detect the RAR repetition number based on the narrow band to which the RAR is assigned and the PRACH repetition level and receive the RAR properly. Further, it is possible to notify the RAR repetition number implicitly without changing the existing DCI format.

(Radio Communication System)

A configuration of a radio communication system according to an embodiment of the present invention will be described below. In this radio communication system, radio communication methods according to the above-mentioned embodiments of the present invention are applied. Note that the radio communication methods according to the above-mentioned respective embodiments may be applied alone, or may be applied in combination. Herein, as a user terminal with a usage band limited to a narrow band, an MTC terminal is illustrated, but a user terminal is not limited to an MTC terminal.

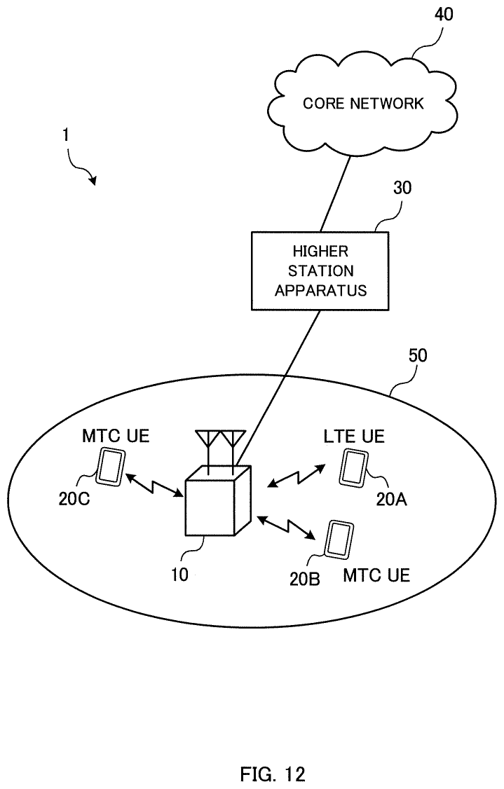

FIG. 12 is a schematic configuration diagram of a radio communication system according to an embodiment of the present invention. A radio communication system 1 shown in FIG. 12 is one example in which an LTE system is employed in a network domain in a machine-type communication (MTC) system. In the radio communication system 1, it is possible to apply Carrier Aggregation (CA) to aggregate a plurality of base frequency blocks (component carries) with a system bandwidth of the LTE system as one unit and/or Dual Connectivity (DC). Further, it is assumed that the LTE system is set to a system bandwidth with a maximum of 20 MHz for both downlink and uplink, but the configuration is not limited thereto. Note that the radio communication system 1 may be called SUPER 3G, LTE-A (LTE-Advanced), IMT-Advanced, 4G, 5G, FRA (Future Radio Access) and the like.

The radio communication system 1 is configured to include a radio base station 10 and a plurality of user terminals 20A, 20B, and 20C wirelessly connected to the radio base station 10. The radio base station 10 is connected to a higher station apparatus 30 and connected to a core network 40 via the higher station apparatus 30. Note that, for example, the higher station apparatus 30 includes an access gateway apparatus, Radio Network Controller (RNC), Mobility Management Entity (MME) and the like, but is not limited thereto.

The plurality of user terminals 20A, 20B, and 20C can communicate with the radio base station 10 in a cell 50. For example, the user terminal 20A is a user terminal (hereinafter, LTE terminal) supporting LTE (up to Rel-10) or LTE-Advanced (including Rel-10 and beyond) and the other user terminals 20B and 20C are MTC terminals that are communication devices in the MTC system and their usage bands are limited to a narrow band (frequency block) that is a part of the system band. Hereinafter, in the case where the distinction is not required in particular, the user terminals 20A, 20B, and 20C are simply called user terminals 20.

Note that each, of the MTC terminals 20B and 20C is a terminal supporting various types of communication schemes such as LTE and LTE-A, and may be a mobile communication terminal, not limited to a fixed communication terminal such as an electric meter, gas meter, and vending machine. Further, the user terminal 20 may communicate directly with another user terminal 20, or may communicate with another user terminal 20 via the radio base station 10.

In the radio communication system 1, as radio access schemes, OFDMA (Orthogonal Frequency Division Multiple Access) is applied on downlink, and SC-FDMA (Single Carrier-Frequency Division Multiple Access) is applied on uplink. OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of a single or contiguous blocks for each terminal so that a plurality of terminals uses mutually different bands, and thereby reducing interference among terminals. Note that the radio access schemes on uplink and downlink are not limited to these combinations.

In the radio communication system 1, as channels on downlink, a downlink shared channel (PDSCH: Physical Downlink Shared Channel) shared by each user terminal 20, a broadcast channel (PBCH: Physical Broadcast Channel), a downlink L1/L2 control channel and the like are used. User data, higher layer control information, and predetermined SIB (System Information Block) are transmitted on the PDSCH. Further, MIB (Master Information Block) is transmitted on the PBCH.

The downlink L1/L2 control channels include PDCCH (Physical Downlink Control Channel), EPDCCH (Enhanced Physical Downlink Control Channel), PCFICH (Physical Control Format Indicator Channel), PHICH (Physical Hybrid-ARQ Indicator Channel), MPDCCH (Machine type communication Physical Downlink Control Channel) and the like. Downlink Control Information (DCI) including scheduling information of the PDSCH and PUSCH and the like is transmitted on the PDCCH. The number of OFDM symbols used in the PDCCH is transmitted on the PCFICH. A receipt confirmation signal (ACK/NACK) of HARQ for the PUSCH is transmitted on the PHICH. The EPDCCH/MPDCCH are frequency division multiplexed with the PDSCH (downlink shared data channel) and used in transmission of the DCI and the like similar to the PDCCH. The MPDCCH is transmitted with a narrow band (frequency block) that is a part of the system band.

In the radio communication system 1, as channels on uplink, an uplink shared channel (PUSCH: Physical Uplink Shared Channel) shared by each user terminal 20, an uplink control channel (PUCCH: Physical Uplink Control Channel), a random access channel (PRACH: Physical Random Access Channel) and the like are used. User data and higher layer control information are transmitted on the PUSCH. Further, radio quality information (CQI: Channel Quality Indicator) of downlink, receipt confirmation signal and the like are transmitted on the PUCCH. Random access preamble (RA preamble) for establishing connection with the cell is transmitted on the PRACH.

### Radio Base Station

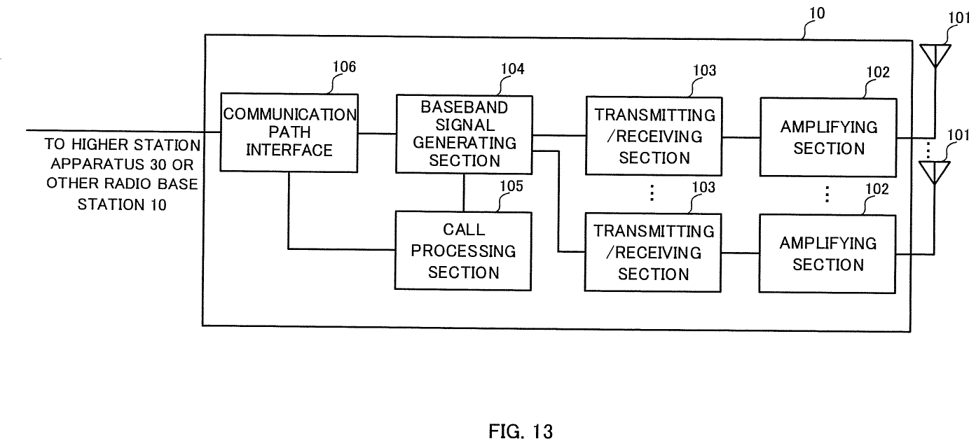

FIG. 13 is a diagram showing one example of an entire configuration of the radio base station according to an embodiment of the present invention. The radio base station 10 is provided with a plurality of transmission/reception antennas 101, amplifying sections 102, transmission/reception sections 103, a baseband signal processing section 104, a call processing section 105, and a transmission path interface 106. Note that the transmission/reception section 103 is configured by a transmission section and a reception section.

User data transmitted to the user terminal 20 from the radio base station 10 on downlink is input to the baseband signal processing section 104 from the higher station apparatus 30 via the transmission path interface 106.

The baseband signal processing section 104 performs, on the user data, processing of PDCP (Packet Data Convergence Protocol) layer, segmentation and concatenation of the user data, transmission processing of RLC (Radio Link Control) layer such as RLC retransmission control, MAC (Medium Access Control) retransmission control (for example, transmission processing of HARQ (Hybrid Automatic Repeat reQuest)), scheduling, transmission format selection, channel coding, Inverse Fast Fourier Transform (IFFT) processing, precoding processing and the like to transfer the user data to each of the transmission/reception sections 103. Further, the baseband signal processing section 104 performs, also on a downlink control signal, transmission processing such as channel coding and Inverse Fast Fourier Transform to transfer the downlink control signal to each of the transmission/reception sections 103.

The transmission/reception section 103 receives a downlink signal and transmits an uplink signal. The downlink signal includes a downlink control signal (for example, PDCCH/EPDCCH/MPDCCH and the like), a downlink data signal (for example, PDSCH and the like), and a downlink reference signal (for example, CSI-RS (Channel State Information-Reference Signal), CRS (Cell-specific Reference Signal) and the like. The uplink signal includes an uplink control signal (for example, PUCCH and the like), uplink data signal (for example, PUSCH and the like), uplink reference signal (for example, SRS (Sounding Reference Signal), DM-RS (DeModulation-Reference Signal) and the like), and random access signal (PRACH: Physical Random Access Channel).

Specifically, the transmission/reception section 103 converts the baseband signal, which is subjected to precoding for each antenna and is output from the baseband signal processing section 104, into a signal with a radio frequency to transmit the signal. The radio-frequency signal frequency-converted in the transmission/reception section 103 is amplified in the amplifying section 102 and transmitted from the transmission/reception antenna 101. It is possible for the transmission/reception section 103 to transmit and receive various types of signals with the frequency block (narrow band) (for example, 1.4 MHz) limited by the system bandwidth (for example, 1 component carrier).

The transmission/reception section 103 may be a transmitter/receiver, transmission/reception circuit, or a transmission/reception device described based on the common recognition in the technical field according to the present invention.

On the other hand, concerning the uplink signal, the radio-frequency signals received by the transmission/reception antennas 101 are amplified in the amplifying sections 102, respectively. Each of the transmission/reception sections 103 receives the uplink signal amplified in the amplifying sections 102. The transmission/reception section 103 frequency-converts the received signal into a baseband signal to output it to the baseband signal processing section 104.

The baseband signal processing section 104 performs, on user data included in the input uplink signal, Fast Fourier Transform (FFT) processing, Inverse Discrete Fourier Transform (IDFT) processing, error correcting decoding, reception processing of MAC retransmission control, and reception processing of RLC layer and PDCP layer to transfer the user data to the higher station apparatus 30 via the transmission path interface 106. The call processing section 105 performs call processing such as setting and release of a communication channel, state management of the radio base station 10, and management of radio resources.

The transmission path interface 106 performs transmission and reception of signals with the higher station apparatus 30 via a predetermined interface. Further, the transmission path interface 106 may perform transmission and reception of signals (backhaul signaling) with the adjacent radio base station 10 via an inter-base station interface (for example, optical fiber or X2 interface in conformity with CPRI (Common Public Radio Interface)).

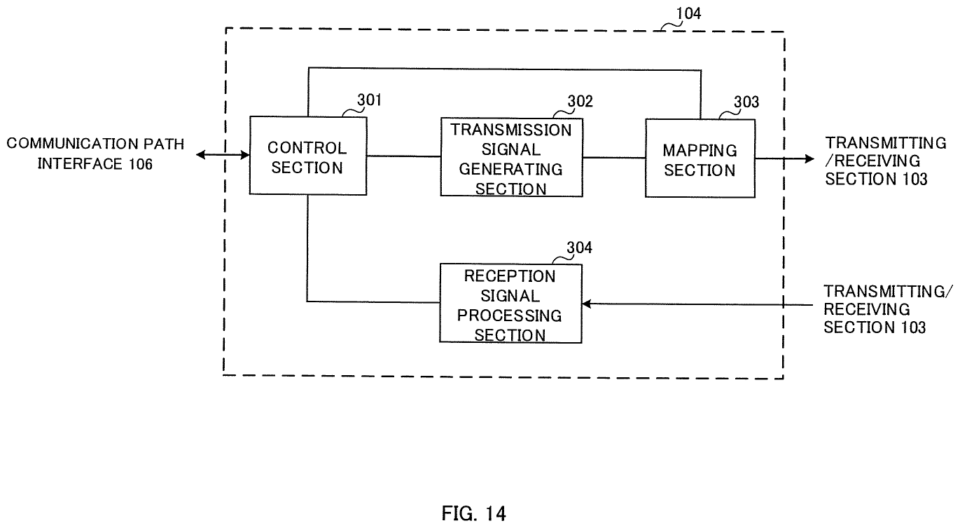

FIG. 14 is a diagram showing one example of a function configuration of the radio base station according to this embodiment. Note that FIG. 14 mainly illustrates function blocks of a characteristic portion in this embodiment, and it is assumed that the radio base station 10 has other function blocks required for radio communications. As shown in FIG. 14, the baseband signal processing section 104 includes a control section 301, a transmission signal generating section 302, a mapping section 303, and a received signal processing section 304.

The control section 301 controls scheduling (for example, resource assignment) of a downlink data signal (PDSCH) and a downlink control signal (at least one of PDCCH, EPDCCH, and MPDCCH). Further, the control section 301 also performs control of scheduling of the system information, synchronization signal, and downlink reference signals (CRS, CSI-RS, DM-RS and the like). Furthermore, the control section 301 controls scheduling of the uplink reference signal, uplink data signal (PUSCH), uplink control signal (PUCCH) and the like.

The control section 301 controls the transmission signal generating section 302 and the mapping section 303 so as to assign various types of signals to narrow bands to transmit the signals to the user terminal 20. For example, the control section 301 performs control so as to transmit the system information (MIB, SIB) on downlink, downlink control signal (MPDCCH), downlink data signal (PDSCH) and the like with narrow bands. Note that the downlink data signal (PDSCH) includes a response signal (RAR) to the random access signal (PRACH) and higher layer control information.

Further, the control section 301 determines the repetition number of the response signal based on the random access signal (PRACH) repetition level (CE level) and the number of user terminals 20 multiplexed within the response signal (RAR) to the random access signal. Note that the control section 301 may estimate the repetition level of the random access signal based on a measurement result in the user terminal 20.

Further, the control section 301 performs control so as to transmit information for detection for detecting the determined repetition number to the user terminal 20. Herein, the information for detection may be information indicating the number of user terminals 20 multiplexed within the response signal (RAR) to the random access signal (PRACH) (Aspect 1), may be information indicating the offset to the random access signal repetition number (Aspect 2, Aspect 3), may be information indicating the Transport Block Size (TBS) of the above-mentioned response signal (Aspect 4), or may be information indicating a plurality of narrow bands that is candidates of usage bands (Aspect 5).

Further, the control section 301 controls the transmission signal generating section 302 and the transmission/reception section 103 so as to transmit the above-mentioned response signal (RAR) with repetition the number of times corresponding to the repetition number determined above. Furthermore, the control section 301 controls the received signal processing section 304 and the transmission/reception section 103 so as to receive the above-mentioned random access signal (PRACH) with repetition the number of times corresponding to the repetition number indicated by the repetition level (CE level) and combine received signals.

The control section 301 may be a controller, a control circuit, or a control device described based on the common recognition in the technical field according to the present invention.

The transmission signal generating section 302 generates a downlink signal (including the response signal (RAR) to the random access signal (PRACH)) based on an instruction from the control section 301 to output the signal to the mapping section 303. For example, the transmission signal generating section 302 generates a downlink grant (downlink assignment) for notifying assignment information of a downlink data signal and an uplink grand for notifying assignment information of an uplink data signal based on the instruction from the control section 301.

The transmission signal generating section 302 may be a signal generator, a signal generating circuit, or a signal generating device described based on the common recognition in the technical field according to the present invention.

The mapping section 303 maps the downlink signal generated in the transmission signal generating section 302 to radio resources (for example, a maximum of 6 resource blocks) with a predetermined narrow band to output the signal to the transmission/reception section 103 based on the instruction from the control section 301. The mapping section 303 may be a mapper, a mapping circuit, or a mapping device described based on the common recognition in the technical field according to the present invention.

The received signal processing section 304 performs reception processing (for example, demapping, demodulation, decoding and the like) on the received signal input from the transmission/reception sections 103. Herein, the received signal is, for example, the uplink signal (uplink data signal (PUCCH), uplink control signal (PUCCH), uplink reference signal (SRS, DMRS), random access signal (PRACH) and the like) transmitted from the user terminal 20. The received signal processing section 304 outputs the received information to the control section 301.

Further, the received signal processing section 304 may measure received power (for example, RSRP), received quality (for example, RSRQ), channel state and the like using the received signal. A measurement result may be output to the control section 301.

The received signal processing section 304 may be configured with a signal processor, a signal processing circuit, or a signal processing device, and a measurement instrument, a measurement circuit, or a measurement device described based on the common recognition in the technical field according to the present invention.

### User Terminal

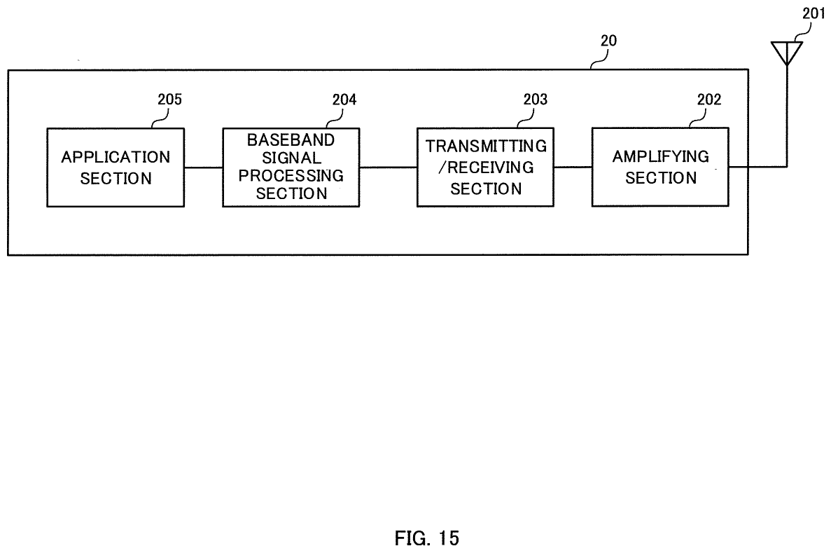

FIG. 15 is a diagram showing one example of an entire configuration of the user terminal according to this embodiment. Note that although detailed description is omitted herein, a normal LTE terminal may operate so as to behave as an MTC terminal. The user terminal 20 includes a transmission/reception antenna 201, an amplifying section 202, a transmission/reception section 203, a baseband signal processing section 204, and an application section 205. Note that the transmission/reception section 203 is configured with a transmission section and a reception section. Further, the user terminal 20 may include a plurality of transmission/reception antennas 201, a plurality of amplifying sections 202, a plurality of transmission/reception sections 203 and the like.

The radio-frequency signal received by the transmission/reception antenna 201 is amplified in the amplifying section 202. The transmission/reception section 203 receives downlink signals (including downlink control signal (PDCCH/EPDCCH/MPDCCH), downlink data signal (PDSCH), downlink reference signal (CSI-RS, CRS and the like), and response signal (RAR) to random access signal (PRACH)) amplified in the amplifying section 202. The transmission/reception section 203 frequency-converts the received signal into a baseband signal to output it to the baseband signal processing section 204.

Specifically, the transmission/reception section 203 receives information for detection of the repetition number of the response signal (RAR) to the random access signal (PRACH). The information for detection may be included in the downlink control signal (MPDCCH), or may be included in higher layer control information (for example, RRC signaling information, MIB, SIB and the like). Note that details of information for detection are as described above.

Further, the transmission/reception section 203 transmits uplink signals (including uplink control signal (PUCCH), uplink data signal (PUSCH), uplink reference signal (DM-RS, SRS), random access signal (PRACH) and the like) output from the baseband signal processing section 204. The transmission/reception section 203 may be a transmitter/receiver, a transmission/reception circuit, or a transmission/reception device described based on the common recognition in the technical field according to the present invention.

The baseband signal processing section 204 performs, on the input baseband signal, FFT processing, error correcting decoding, reception processing of retransmission control and the like. Downlink user data is transferred to the application section 205. The application section 205 performs processing concerning layers higher than physical layer and MAC layer. Further, among the downlink data, broadcast information is also transferred to the application section 205.

On the other hand, uplink user data is input to the baseband signal processing section 204 from the application section 205. The baseband signal processing section 204 performs the transmission processing of retransmission control (for example, transmission processing of HARQ), channel coding, precoding, Discrete Fourier Transform (DFT) processing, IFFT processing and the like on uplink user data to transfer it to the transmission/reception section 203. The transmission/reception section 203 converts the baseband signal output from the baseband signal processing section 204 into a signal with a radio frequency band to transmit the signal. The radio-frequency signal frequency-converted in the transmission/reception section 203 is amplified by the amplifying section 202 and transmitted from the transmission/reception antenna 201.

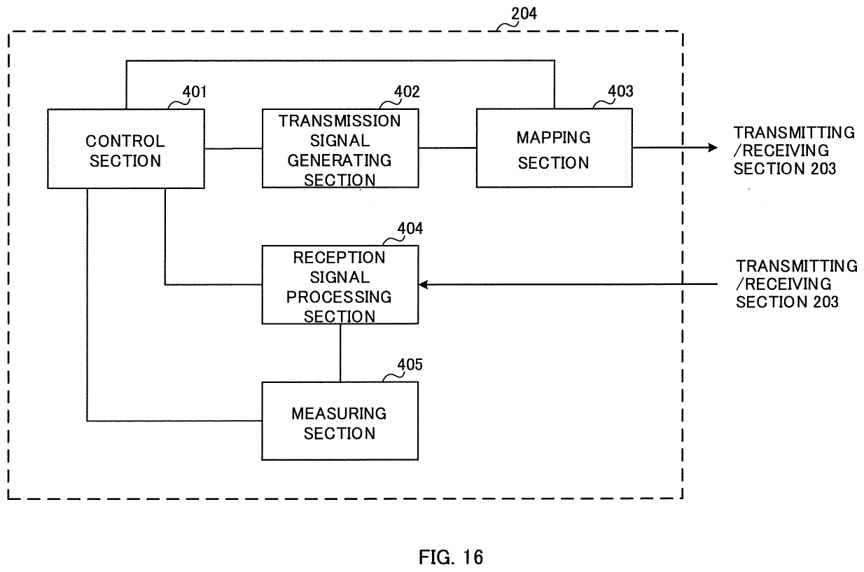

FIG. 16 is a diagram showing one example of a function configuration of the user terminal according to this embodiment. Note that FIG. 16 mainly illustrates function blocks of a characteristic portion in this embodiment, and it is assumed that the user terminal 20 has other function blocks required for radio communications. As shown in FIG. 16, the baseband signal processing section 204 of the user terminal 20 includes a control section 401, a transmission signal generating section 402, a mapping section 403, a received signal processing section 404, and a measurement section 405.

The control section 401 controls the transmission signal generating section 402 and mapping section 403. The control section 401 acquires the downlink control signals (PDCCH/EPDCCH/MPDCCH) and the downlink data signal (PDSCH) transmitted from the radio base station 10 from the received signal processing section 404. Note that the downlink data signal (PDSCH) includes the response signal (RAR) to the random access signal (PRACH) and higher layer control information.

The control section 401 determines the random access signal (PRACH) repetition level (CE level) based on the result of measurement (for example, received signal intensity (RSRP) and received signal quality (RSRQ)) by the measurement section 405. Further, the control section 401 controls the transmission signal generating section 402, the mapping section 403, and the transmission/reception section 203 so as to transmit the random access signal (PRACH) with repetition based on the repetition level.

Further, the control section 401 detects the repetition number of the response signal (RAR) to the random access signal (PRACH) and controls the received signal processing section 404 so as to combine the response signals (RAR) the number of times corresponding to the detected repetition number. Specifically, the control section 401 detects the repetition number of the above-mentioned response signal (RAR) based on the random assess signal repetition level (CE level) and the information for detection received in the transmission/reception section 203.

For example, the control section 401 may detect the repetition number of the above-mentioned response signal (RAR) based on the random access signal (PRACH) repetition level and the number of user terminals 20 multiplexed within the above-mentioned response signal (RAR) (Aspect 1).

Further, the control section 401 may detect the repetition number of the above-mentioned response signal (RAR) based on the random access signal (PRACH) repetition level and the offset to the random access signal repetition number (Aspect 2 and Aspect 3). Herein, the offset may be determined for each repetition level of the random access signal (FIG. 7), or may be determined in common to the repetition levels (FIG. 8). Note that the random access signal repetition number is indicated by the repetition level.

Further, the control section 401 may detect the above-mentioned repetition number of the response signal based on the random access signal (PRACH) repetition level and the Transport Block Size (TBS) associated with the number of user terminals 20 multiplexed within the above-mentioned response signal (RAR) (Aspect 4). Herein, the information indicating the TBS may be the MCS index associated with the TBS index indicating the TBS.

Further, the control section 401 may detect the repetition number of the above-mentioned response signal based on the random access signal (PRACH) repetition level and the narrow bands (frequency blocks) to which the above-mentioned response signal (RAR) is assigned (Aspect 5). Herein, each of the plurality of narrow bands that is candidates of usage bands of the user terminal 20 is associated with the number of user terminals 20 multiplexed within the above-mentioned response signal (FIG. 11). This association is set in advance or set by higher layer signaling in the user terminal 20.

The control section 401 may be a controller, a control circuit, or a control device described based on the common recognition in the technical field according to the present invention. Note that it is possible for the control section 401 to configure the measurement section according to the present invention together with the measurement section 405.

The transmission signal generating section 402 generates an uplink signal to output it to the mapping section 403 based on the instruction from the control section 401. For example, the transmission signal generating section 402 generates a random access signal (PRACH) based on the instruction from the control section 401.

Further, the transmission signal generating section 402 generates an uplink data signal (PUSCH) based on the instruction from the control section 401. For example, in the case where the uplink grant is included in the downlink control signal notified from the radio base station 10, the transmission signal generating section 402 is instructed to generate an uplink data signal by the control section 401.

The transmission signal generating section 402 may be a signal generator, a signal generating circuit, or a signal generating device described based on the common recognition in the technical field according to the present invention.

The mapping section 403 maps the uplink signal generated in the transmission signal generating section 402 to radio resources (for example, a maximum of 6 PRBs) to output the signal to the transmission/reception section 203 based on the instruction from the control section 401. The mapping section 403 may be a mapper, a mapping circuit, or a mapping device described based on the common recognition in the technical field according to the present invention.

The received Signal processing section 404 performs reception processing (for example, demapping, demodulation, decoding and the like) on the received signal input from the transmission/reception section 203. Herein, the received signal is, for example, the downlink signal (downlink control signal (PDCCH/EPDCCH/MPDCCH), downlink data signal (PDSCH) and the like) transmitted from the radio base station 10. Note that the downlink data signal (PDSCH) includes the response signal (RAR) to the random access signal (PRACH) and higher layer control information.

The received signal processing section 404 outputs the received information to the control section 401. The received signal processing section 404 outputs, for example, the broadcast information, system information, RRC signaling, DCI and the like to the control section 401. Further, the received signal processing section 404 outputs the received signal and signal after reception processing to the measurement section 405.

The received signal processing section 404 may be a signal processor, a signal processing circuit, or a signal processing device described based on the common recognition in the technical field according to the present invention. Further, it is possible for the received signal processing section 404 to configure the reception section according to the present invention.

The measurement section 405 measures CSI of narrow bands (frequency blocks) subjected to frequency hopping at a predetermined period based on the instruction from the control section 401. The CSI includes at least one of a rank identifier (RI), channel quality identifier (CQI), and precoding matrix identifier (PMI). Further, the measurement section 405 may measure received power (RSRP), received quality (RSRQ) and the like using the received signal. Note that the processing result and measurement result may be output to the control section 401.

The measurement section 405 may be a measure, a measurement circuit, or a measurement device described based on the common recognition in the technical field according to the present invention.

Note that the block diagram used for description of the above-mentioned embodiments shows blocks for each function. These function blocks (configuration portions) are actualized by an arbitrary combination of hardware and software. Further, a measure for realizing each function block is not limited in particular. That is, each function block may be realized by one physically coupled device, or may be realized by a plurality of devices by connecting two or more physically separate devices in a wired or wireless manner.

For example, a part or all of the functions of the radio base station 10 and the user terminal 20 may be realized using hardware such as ASIC (Application Specific Integrated Circuit), PLD (Programmable Logic Device), and FPGA (Field Programmable Gate Array). Further, the radio base station 10 and the user terminal 20 may be realized by a computer apparatus including a processor (CPU: Central Processing Unit), communication interface for network connection, memory, and computer readable storage medium holding programs. In other words, the radio base station, the user terminal and the like according to an embodiment of the present invention may function as a computer that performs processing of the radio communication method according to the present invention.

Herein, the processor, memory and the like are connected by a bus for communicating information. Further, the computer readable storage medium is, for example, a flexible disc, a magneto-optical disc, a ROM (Read Only Memory), an EPROM (Erasable Programmable ROM), a CD-ROM (Compact Disc-ROM), a RAM (Random Access Memory), a hard disk and the like. Furthermore, programs may be transmitted from a network via an electrical communication line. Moreover, the radio base station 10 and the user terminal 20 may each include an input apparatus such as an input key, and an output apparatus such as a display.

The function configurations of the radio base station 10 and the user terminal 20 may be realized by the above-mentioned hardware, may be realized by software modules executed by the processor, or may be realized by a combination of both. The processor causes the operating system to operate to control the entire user terminal 20. Further, the processor reads programs, software modules, and data from the storage medium into the memory to perform various types of processing in accordance therewith.

Herein, the program may be any program that causes a computer to perform each operation described in each of the above-mentioned embodiments. For example, the control section 401 of the user terminal 20 may be realized by the control program that is stored in the memory and operated by the processor, and the other function blocks may be realized similarly.

Further, the software, commands and the like may be transmitted and received via a transmission medium. For example, in the case where the software is transmitted from a website, server or another remote source using the wired technique such as a coaxial cable, optical fiber cable, twist pair, and digital subscriber line (DSL), or the radio technique such as infrared, radio, and microwave, these wired technique and/or radio technique are included in the definition of the transmission medium.

Note that the terms described in the Description and/or terms required to understand the Description may be replaced with terms having the same or similar meanings. For example, channels and/or symbols may be signals (signaling). Further, signals may be messages. Furthermore, the component carrier (CC) may be called carrier frequency, cell and the like.

Further, the information, parameters and the like described in the Description may be represented by absolute values, may be represented by relative values from a predetermined value, or may be represented by another piece of information corresponding thereto. For example, the radio resource may be one specified by an index.

The information, signals and the like described in the Description may be represented using any of a variety of different techniques. For example, the data, instructions, commands, information, signals, bits, symbols, chips and the like referred to across the entire above-mentioned description may be represented by voltages, currents, electromagnetic waves, magnetic fields or magnetic particles, and optical fields or photons, or an arbitrary combination of those.

Each of the Aspects/Embodiments described in the Description may be used alone or may be used in combination, or may be switched to another accompanying execution. Further, notification of predetermined information (for example, notification of “being X”) is not limited to that performed explicitly, but may be that performed implicitly (for example, by not performing notification of the predetermined information).

The notification of information is not limited to that in the Aspects/Embodiments described in the Description and may be performed by another method. For example, the notification of information may be performed by physical layer signaling (for example, DCI (Downlink Control Information), UCI (Uplink Control Information)), higher layer signaling (for example, RRC (Radio Resource Control) signaling, MAC (Medium Access Control) signaling, broadcast information (MIB (Master Information Block), SIB (System Information Block))), and other signals, or a combination of those. Further, the RRC signaling may be called RRC message and for example, may be RRC Connection Setup message, RRC Connection Reconfiguration message and the like.

Each of the Aspects/Embodiments described in the Description may be applied to the system that uses LTE (Long Term Evolution), LTE-A (LTE-Advanced), SUPER, 3G, IMT-Advanced, 4G, 5G, FRA (Future Radio Access), CDMA 2000, UMB (Ultra Mobile Broadband), IEEE 802.11 (Wi-Fi), IEEE 802.16 (WiMAX), IEEE 802.20, UWB (Ultra-WideBand), Bluetooth (Registered Trademark), and other appropriate systems and/or the next-generation system enhanced based on those.

The processing procedure, sequence, flowchart and the like of each of the Aspects/embodiments described in the Description may be changed in order unless there is a contradiction. For example, in the methods described in the Description, elements of a variety of steps are presented in illustrative orders and the orders are not limited to the particular orders presented.

As described above, the present invention is described in detail, but it is obvious to a person skilled in the art that the invention is not limited to the embodiment described in the Description. The present invention is capable of being carried into practice as modified and changed aspects without departing from the subject matter and scope of the invention defined by the descriptions of the scope of the claims. Accordingly, the descriptions of the Description are intended for illustrative explanation, and do not have any restrictive meaning to the invention.

The present application is based on Japanese Patent Application No. 2015-159986 filed on Aug. 13, 2015, the entire content of which is expressly incorporated by reference herein.

1. A user terminal with a usage band limited to a frequency block that is a part of a system band, comprising:
a transmission section that transmits a random access signal with repetition;
a reception section that receives a response signal to the random access signal with repetition; and
a control section that detects a repetition number of the response signal, wherein
the reception section receives information for detection of the repetition number of the response signal, and
the control section detects the repetition number of the response signal based on a repetition level of the random access signal and the information for detection.

2. The user terminal according to claim 1, wherein
the reception section receives information indicating a number of user terminals multiplexed within the response signal as the information for detection, and
the control section detects the repetition number of the response signal based on the repetition level of the random access signal and the number of the user terminals.

3. The user terminal according to claim 1, wherein
the reception section receives information indicating an offset for a repetition number of the random access signal as the information for detection and the offset is defined for each repetition level of the random access signal, and
the control section detects the repetition number of the response signal based on a repetition number indicated by the repetition level of the random access signal and the offset.

4. The user terminal according to claim 1, wherein
the reception section receives information indicating an offset to the repetition number of the random access signal as the information for detection and the offset is defined in common for all the repetition levels of the random access signal, and
the control section detects the repetition number of the response signal based on a repetition number indicated by the repetition level of the random access signal and the offset.

5. The user terminal according to claim 1, wherein
the reception section receives information indicating a transport block size (TBS) associated with the number of user terminals multiplexed within the response signal as the information for detection, and
the control section detects the repetition number of the response signal based on the repetition level of the random access signal and the TBS.

6. The user terminal according to claim 5, wherein
the information indicating the TBS is a modulation and coding scheme (MCS) index associated with a TBS index indicating the TBS.

7. The user terminal according to claim 1, wherein
the reception section receives information indicating a plurality of frequency blocks as the information for detection and each of the plurality of frequency blocks is associated with the number of user terminals multiplexed within the response signal, and
the control section detects the repetition number of the response signal based on the repetition level of the random access signal and the frequency block to which the response signal is assigned.

8. The user terminal according to claim 1, wherein the frequency block is 1.4 MHz and consists of six resource blocks.

9. A radio base station for communicating with a user terminal with a usage band limited to a frequency block that is a part of a system band, comprising:
a reception section that receives a random access signal with repetition;
a transmission section that transmits a response signal to the random access signal with repetition; and
a control section that determines a repetition number of the response signal based on a repetition level of the random access signal and a number of user terminals multiplexed within the response signal, wherein
the transmission section transmits information for detection of the determined repetition number.

10. A radio communication method in a user terminal with a usage band limited to a frequency block that is a part of a system band, comprising:
transmitting a random access signal with repetition;
receiving a response signal to the random access signal with repetition; and
detecting a repetition number of the response signal, wherein
the user terminal receives information for detection of the repetition number of the response signal and detects the repetition number of the response signal based on a repetition level of the random access signal and the information for detection.

11. The user terminal according to claim 2, wherein the frequency block is 1.4 MHz and consists of six resource blocks.

12. The user terminal according to claim 3, wherein the frequency block is 1.4 MHz and consists of six resource blocks.

13. The user terminal according to claim 4, wherein the frequency block is 1.4 MHz and consists of six resource blocks.

14. The user terminal according to claim 5, wherein the frequency block is 1.4 MHz and consists of six resource blocks.

15. The user terminal according to claim 6, wherein the frequency block is 1.4 MHz and consists of six resource blocks.

16. The user terminal according to claim 7, wherein the frequency block is 1.4 MHz and consists of six resource blocks.
